(19) United States
(12) Patent Application Publication
(10) Pub. No.: US 2009/0112675 A1
(43) Pub. Date: Apr. 30, 2009

(54) AUTOMATED ORDER FULFILLMENT SYSTEM AND METHOD

(76) Inventor: Jeff Servais, New Berlin, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/932,215

(22) Filed: Oct. 31, 2007

(51) Int. Cl. G06Q 10/00

(52) U.S. Cl. 705/8; 705/7

(57) ABSTRACT

A method of operating an automated order fulfillment system for concurrently processing multiple orders, the automated order fulfillment system includes an automated storage and retrieval system having a number of storage units, each storage unit is operable to support a number of stored units, and at least one building station operable to receive stored units from the automated storage and retrieval system. The method includes the acts of generating multiple orders, each order being associated with a building station, sequentially identifying the orders associated with the building station, accessing information relating to stored units inventory, the information including the number of stored units in each storage unit of the automated storage and retrieval system, determining an allocating parameter, the allocating parameter including a date and a predetermined window of time, determining a quantity of stored units needed based on the allocating parameter and the information, and allocating stored units from the automated storage and retrieval system to the orders associated with a building station in response to determining the quantity of stored units needed.

### BACKGROUND

The present invention relates to storage warehouse management systems and product handling systems. More specifically, the present invention relates to an integral system for storing, managing and retrieving quantities of a product in an efficient manner. Many warehouse systems are operated to store quantities of a product such that the product is readily available. In this regard, the use of shelving systems generally facilitates the operation of the warehouse systems. Properly designed shelving systems can make the process of storing and retrieving product in a shelving system more efficient. However, there is the need for an integral system that is operable to receive, store and manage quantities product while concurrently tracking the quantities of product throughout all processes in the system.

### SUMMARY

In one embodiment, the invention provides a method of operating an automated order fulfillment system for concurrently processing multiple orders, the automated order fulfillment system including an automated storage and retrieval system having a number of storage units, each storage unit is operable to support a number of stored units, and at least one building station operable to receive stored units from the automated storage and retrieval system. The method includes the acts of generating the multiple orders, each order being associated with a building station, sequentially identifying the orders associated with the building station, accessing information relating to stored units inventory, the information including the number of stored units in each storage unit of the automated storage and retrieval system, determining an allocating parameter, the allocating parameter including a date and a predetermined window of time, determining a quantity of stored units needed based on the allocating parameter and the information, and allocating stored units from the automated storage and retrieval system to the orders associated with a building station in response to determining the quantity of stored units needed.

In another embodiment, the invention provides a method of operating an automated order fulfillment system with an automated storage and retrieval system having a number of storage units, each storage unit operable to support a number of stored units, and a number of storage and retrieval machines operable to transport stored units to and from the number of storage units, each of the storage and retrieval machines including a number of shuttles. The method includes the acts of determining a parameter associated with an order, determining the quantity of useful stored units from the number of stored units in each storage unit based on the parameter associated to the order, and ranking the quantity of useful stored units in each storage unit. The act of ranking the quantity of stored units includes comparing the quantity of useful stored units in each storage unit to at least one of a first quantity related to the order and a second quantity related to the condition of the storage and retrieval machine associated with the storage unit, and sorting the quantity of useful stored units based on a predicted status of the storage unit determined by simulating removal of the quantity of useful stored units from the storage unit.

In another embodiment, the invention provides a method of operating an automated order fulfillment system including a number of aisles formed with storage units, the storage units being operable to support a number of stored units, and a storage and retrieval machine associated with each aisle, the storage and retrieval machine including at least one shuttle. The method includes the acts of sequentially verifying that the storage and retrieval machine associated with each aisle is available to transport stored units from the corresponding aisle, and determining the quantity of stored units needed from one aisle as a result of verifying that the corresponding storage and retrieval machine is available to transport stored units from the one aisle. The act of determining the quantity of stored units needed includes comparing a first quantity indicative of a condition of the available storage and retrieval machine to a second quantity indicative of a condition of an order. The method also includes the acts of determining an allocating parameter, the allocating parameter including a date and the predetermined window of time, and if a condition of the determined quantity of stored units needed meets the allocating parameter, storing information of the quantity of stored units needed in a first data structure, or if the condition of the determined quantity of stored units needed does not meet the allocating parameter, storing information of the quantity of stored units needed in a second data structure. The first data structure includes information of the quantity of stored units needed from each of the aisles and is prioritized over the second data structure.

In another embodiment, the invention provides a method of operating an automated order fulfillment system for concurrently processing multiple orders, the automated order fulfillment system including an automated storage and retrieval system operable to support a number of stored units. The method includes the acts of determining an allocating parameter, the allocating parameter including a date and a predetermined window of time, and sorting the stored units in the automated storage and retrieval system based on the allocating parameter. The act of sorting the stored units includes classifying stored units from oldest to newest based on the date of the allocating parameter, and discarding stored units based on the predetermined window of time of the allocating parameter. The method also includes the acts of allocating stored units to an order of the multiple orders based on sorting the stored units, and adjusting at least one of the date and predetermined window of time of the allocating parameter as a result of the allocated stored units not fulfilling the order.

In another embodiment, the invention provides an automated order fulfillment system for concurrently processing multiple orders. The automated order fulfillment system including an automated storage and retrieval system having a number of storage units, each storage unit operable to support a number of stored units, a number of aisles formed with the storage units, and a number of storage and retrieval machines operable to transport stored units to and from the number of storage units, each of the storage and retrieval machines being associated with one aisle and including a number of shuttles. The automated order fulfillment system further including at least one building station operable to receive stored units from the automated storage and retrieval system, and a control system for at least managing the orders. The control system is operable to associate each order to one building station, generate and access information related to stored units inventory, the information including the number of stored units in each storage unit, determine an allocating parameter, the allocating parameter including a date and a predetermined window of time, determine a quantity of stored units needed based on the allocating parameter and the information, and allocate stored units from the automated storage and retrieval system to the orders associated with a building station in response to determining the quantity of stored units needed.

Other aspects of the invention will become apparent by consideration of the detailed description and accompanying drawings.

### BRIEF DESCRIPTION OF THE DRAWINGS

FIG. 1 is a schematic representation of a warehouse implementing an automated order fulfillment system according to one embodiment of the present invention.

FIG. 2 is a schematic representation of a layer handling subsystem of the automated order fulfillment system illustrated in FIG. 1.

FIG. 3 is a schematic representation of a storage/picking subsystem of the automated order fulfillment system illustrated in FIG. 1.

FIG. 4 is a schematic representation of a pallet building subsystem of the automated order fulfillment system illustrated in FIG. 1.

FIG. 5 is a schematic representation of a number of pickup and deposit conveyors of the automated order fulfillment system illustrated in FIG. 1.

FIG. 6 is a schematic representation of an accumulation sorter of the automated order fulfillment system illustrated in FIG. 1.

FIG. 7 is a flow chart indicating a method of processing orders.

FIG. 8 is a schematic representation of a control system to operate the automated order fulfillment system illustrated in FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As should be apparent to one of ordinary skill in the art, the systems, networks and devices shown in the figures are models of what actual systems, networks or devices might be like. As noted, many of the modules and logic structures described are capable of being implemented in software executed by a microprocessor or a similar device or of being implemented in hardware using a variety of components including, for example, application specific integrated circuits (“ASICs”). Terms like “processor” may include or refer to both hardware and/or software. Furthermore, throughout the specification capitalized terms are used. Such terms are used to conform to common practices and to help correlate the description with the coding examples, equations, and/or drawings. However, no specific meaning is implied or should be inferred simply due to the use of capitalization. Thus, the invention is not limited to the specific examples or terminology or to any specific hardware or software implementation or combination of software or hardware.

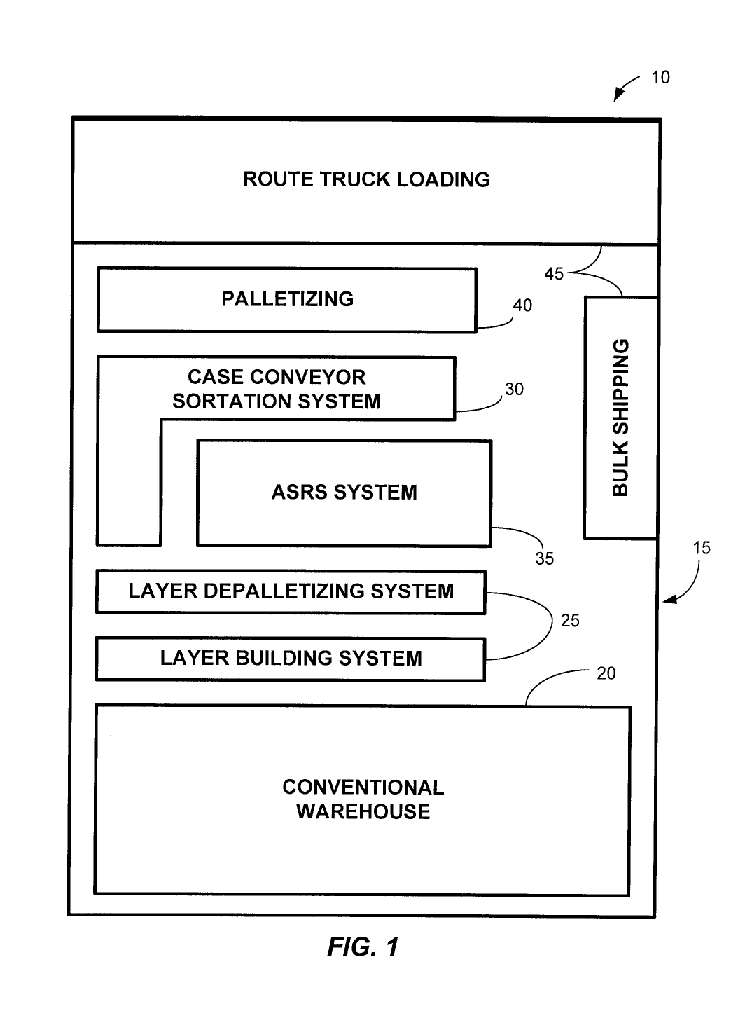

FIG. 1 illustrates a facility 10 implementing an automated order fulfillment system (AOFS) 15 according to one embodiment of the present invention. In the illustrated construction, the AOFS 15 stores and manages units of a product. Depending on the application or industry, the product can include various types of items such as beverages, toys, food, electronics, and other products suitable for transportation in cases. The AOFS 15 is formed with a number of subsystems, each configured to interact with at least another subsystem and to manage the units of product at various stages or locations of the facility 10. More particularly, the AOFS 15 includes a warehouse subsystem 20, a layer handling subsystem 25, a transportation subsystem 30, a storage/picking subsystem 35, a pallet building subsystem 40, and a staging/loading subsystem 45.

The AOFS 15 also includes a control system for operating each, and the interaction between, the subsystems 20, 25, 30, 35, 40, 45. The control system includes a central computer (not shown) to control the operation of a warehouse management system (WMS) and a material handling control system (MHCS). FIG. 8 schematically illustrates an overview of an exemplary control system 46 for controlling the AOFS 15. The control system 46 includes the WMS (element 47), the MHCS (element 48), and subsystems of the AOFS 15 interacting with the WMS and MHCS to process multiple orders, as described in more detail below. The WMS interacts with other external systems to receive customer orders, processes the customer orders into the appropriate format for the MHCS, maintains inventory of the warehouse subsystem 20, and monitors and replenishes the ASRS subsystem 35. The WMS is also responsible for the receiving and shipping of all units of product in the AOFS 15. For example, the WMS processes orders and tracks the location and status of inventory of units of product. The WMS also directs personnel in the facility 10 to perform inventory movement in the AOFS 15.

The MHCS is responsible for interfacing and managing automated equipment in the AOFS 15. The MHCS also operates in conjunction with the WMS to provide inventory control and move product throughout the facility 10. More specifically, the MHCS executes the storing, retrieving, and sorting logic to deliver units of product to the pallet building subsystem 40 in the appropriate sequence. The MHCS includes interface connections with the controllers of storage and retrieval machines (SRMs) and programmable logic controllers (PLC) of the conveyors, as further explained below. These connections allow the MHCS to direct movement of units of product on conveyors and SRMs. Concurrently, the MHCS is operable to track and monitor the units of product within the AOFS based on tracking information provided from these interfaces. The operation and interaction of the subsystems 20, 25, 30, 35, 40, 45 with respect to the WMS and MHCS will be further explained below.

The warehouse subsystem 20 comprises the initial stage of the AOFS 15 and is managed by the WMS. The warehouse subsystem 20 includes an area for receiving units of product. The units of product are generally transported with lift trucks between the receiving area and the layer handling subsystem 25 and/or the staging/loading subsystem 45. In the illustrated construction, each lift truck includes a radio frequency (RF) terminal for communication between lift trucks and the WMS. More particularly, the lift trucks are operable to send information (e.g., type and quantity of units) regarding the units of product being transported and to receive information (e.g., instructions) through the RF terminals for the WMS to manage the storage and handling of the inventory including the units of product being transported. The WMS also interacts with the central computer of the control system for order processing and scheduling based on the inventory managed by the warehouse subsystem 20.

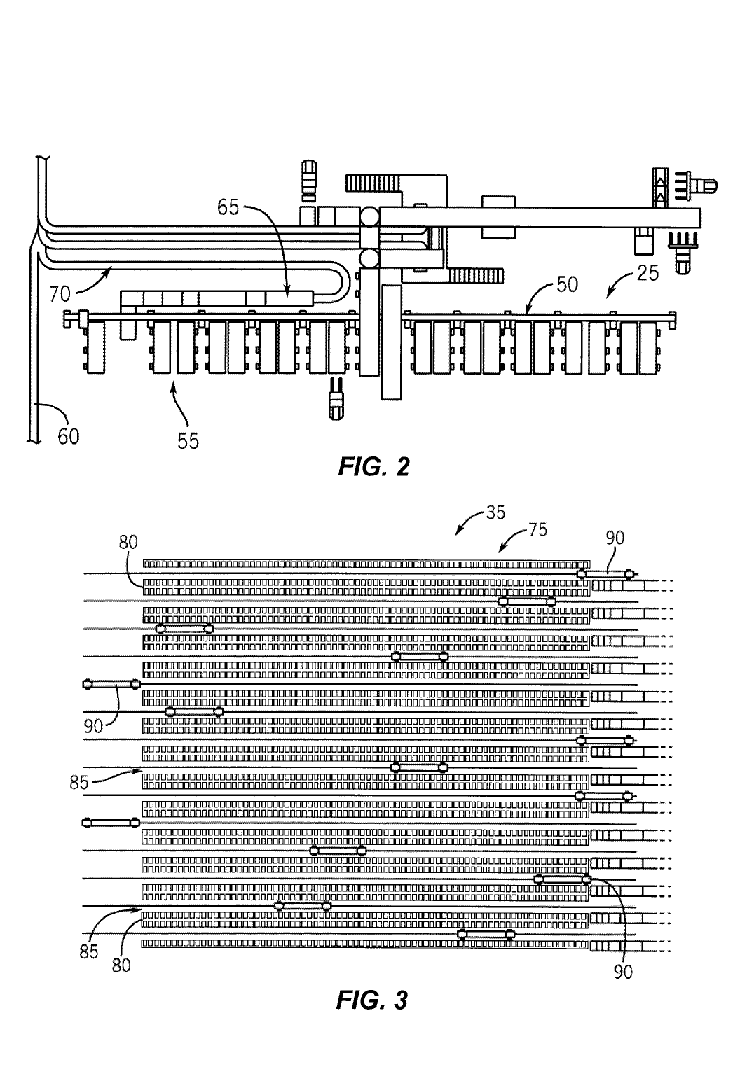

FIG. 2 is a schematic representation of the layer handling subsystem 25 according to one construction of the present invention. The layer handling system 25 includes a layer building module 50, a layer depalletizing module 55, and a low volume depalletizing module 60. Under the direction of the WMS, the warehouse subsystem 20 interacts with the modules 50, 55, and 60 for providing pallets of units of product via lift trucks. More particularly, the layer building module 50 is generally utilized for temporary storage of pallets utilized to fulfill bulk orders present in the control system. In the illustrated construction, lift trucks transport pallets including units of product from the layer building module 50 to the staging/loading subsystem 45.

The layer depalletizing module 55 and the low volume depalletizing module 60 are generally utilized for temporary storage of pallets. The units of product are then moved from the temporarily stored pallets to the storage/picking subsystem 35 by means of the transportation subsystem 30. More specifically, the layer depalletizing module 55 is operable to automatically provide units of product to the storage/picking subsystem 35 via at least one unscrambler 65 (two shown in FIG. 2). The low volume depalletizing module 60 is operable to manually provide units of product to the storage/picking subsystem 35 via a conveyor 70 of the transportation subsystem 30. In other words, the WMS can provide information (via a visual display at the low volume depalletizing module 60, for example) indicating specific units of product to be sent to the storage/picking subsystem 35. In response to the information generated by the WMS, an employee manually loads units of product to the conveyor 70.

The transportation subsystem 30 also includes, in addition to the unscramblers 65 and the conveyor 70 illustrated in FIG. 2, a number of conveyor systems such as belt roller bed, belt slider bed, live roller, air accumulation zero pressure, live roller curves and others. Examples of the conveyor systems are illustrated FIGS. 2-6 and further described below. The conveyor systems of the transportation subsystem 30 are preferably operated with PLC's controlled by the MHCS of the control system. In other words, the transportation subsystem 30 is operated by the MHCS to manage the transportation of units of product between the layer handling subsystem 25, the storage/picking subsystem 35, and the pallet building subsystem 40. In addition, the transportation subsystem 30 can include a number of scanner stations to monitor and verify the units of product. In the illustrated construction, the transportation subsystem 30 includes three CCD camera-based, label scanner stations at an input sorter, an output sorter, and a shipping sorter (not shown), respectively, to monitor the units of product. Monitoring the units of product in the transportation subsystem 30 allows the control system to track the units of product originally scanned at the warehouse subsystem 20. Other constructions can include a different number of scanner stations in the transportation subsystem 30 as well as different or alternate monitoring mechanisms.

FIG. 3 is a schematic representation of the storage/picking subsystem 35 of the AOFS 15. The storage/picking subsystem 35 includes an automated storage and retrieval system (ASRS) 75 providing high density storage as well as automated storage, tracking, and retrieval of units of product. In the illustrated construction, the ASRS 75 includes a number of freestanding racks 80 forming aisles 85. The freestanding racks 80 include storage units or shelves horizontally and vertically aligned with other. Each storage unit is generally designed to support a number of units of product horizontally aligned with each other. In the illustrated construction, it is preferable that units of product are not stacked on one another during storage in the ASRS 75. The ASRS 75 also includes a number of storage and retrieval machines (SRM) 90 for transporting units of product to and from the storage units. In the illustrated construction, one SRM 90 operates one corresponding aisle 85. The SRM 90 includes a double mast supporting a case/unit extractor with a number of shuttles. Generally, the racks 80 are designed such that the number of units of product stored in one storage unit is equal to the number of shuttles of the SRM 90. Each SRM 90 can include a designated controller in communication with the control system such that the WMS and/or MHCS can control the operation of the SRM 90. Storage, tracking, and retrieval of units of product in the ASRS 75 will be described in further detail below.

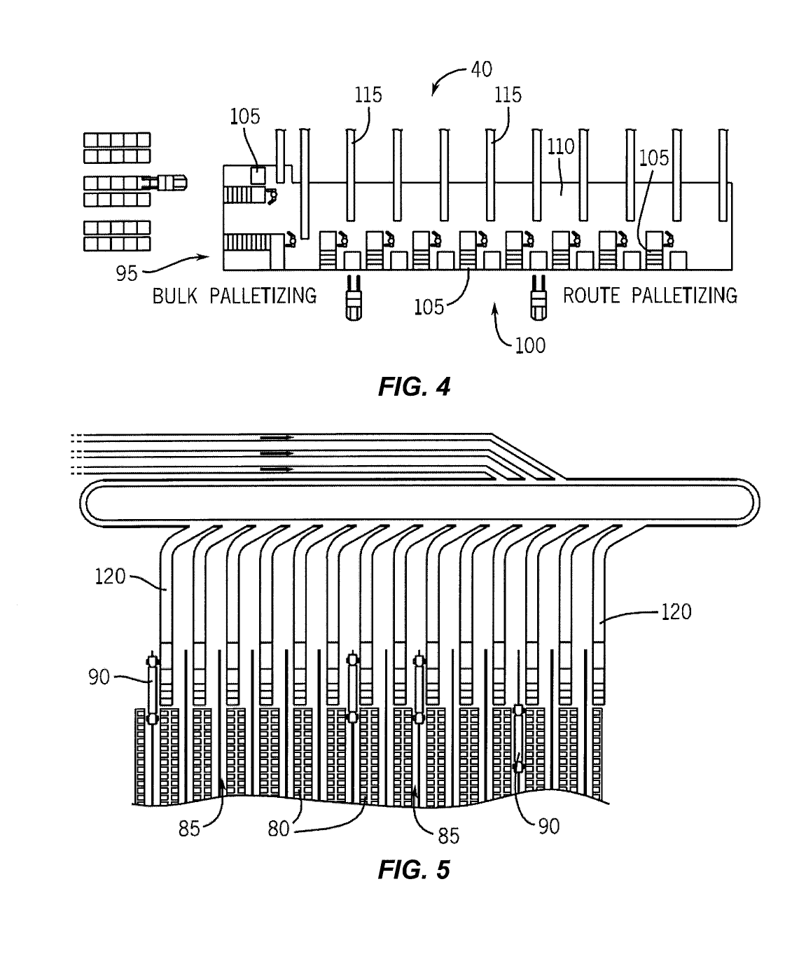

FIG. 4 is a schematic representation of the pallet building subsystem 40 of the AOFS 15. The pallet building subsystem 40 includes a bulk palletizing module 95 and a route palletizing module 100. The bulk palletizing module 95 and the route palletizing module 100 include a number pallet building stations 105 on a raised platform 110. In the illustrated construction, the bulk palletizing module 95 includes two pallet building stations 105 and the route palletizing module 100 includes eight pallet building stations 105. The pallet building stations 105 receive units of product from the storage/picking subsystem 35 via conveyors 115 of the transportation subsystem 30. In addition, the MHCS provides information to each one of the pallet building stations 105 (via a visual display, for example) for employees to manually build pallets with the units of product as the units of product arrive to the corresponding pallet building station 105. The completed pallets 105 are transported from the pallet building subsystem 40 to the staging/loading subsystem 45 under the direction of the WMS.

The staging/loading subsystem 45 generally includes a storage area that is utilized to pre-stage pallets that are transported from the pallet building subsystem 40 and/or the warehouse subsystem 20, as indicated above. Management of inventory as well as loading activities in the staging/loading subsystem 45 is controlled by the WMS.

The operation of the AOFS 15 with the control system can be described as a function of the management of units of product in the AOFS 15. During the receiving process, incoming pallets or containers with units of product are labeled to generate inventory information. The inventory information is entered into the system via RF or PC terminals. The result of the receiving process in the warehouse subsystem 20 is the identification of inventory data (e.g., number of units of product damaged during the receiving process) and determination of subsequent processes for the received units of product. One advantage of the control system is that the system allows for real time tracking and management of product throughout the AOFS 15. As a consequence, employees can be dispatched and prioritized based on current status of the inventory and orders within the system.

Subsequent to receiving product, the system determines the destination of the product. Generally, product can be directed to fulfill an order or to storage. A request to move the pallet is communicated via the RF terminals. Accordingly, an operator can scan the pallet's label and transmit this information via the RF terminals to confirm pickup and delivery of the pallet. Generally, the ASRS 75 is configured to hold a predetermined number of units of product with a specific stock keeping unit (SKU). Accordingly, the WMS determines the number of units to be delivered to the ASRS 75 based on available inventory related to the specific SKU and current orders in the system. The WMS also provides, via the RF terminals, instructions to transport pallets to the layer depalletizing module 55. At the layer depalletizing module 55, units of product are placed from the corresponding pallet onto the singulator or unscrambler 65 to arrange the units of product in a single line configuration towards a scanner station. At the scanner station, the MHCS determines the aisle 85 to which each unit of product is to be delivered.

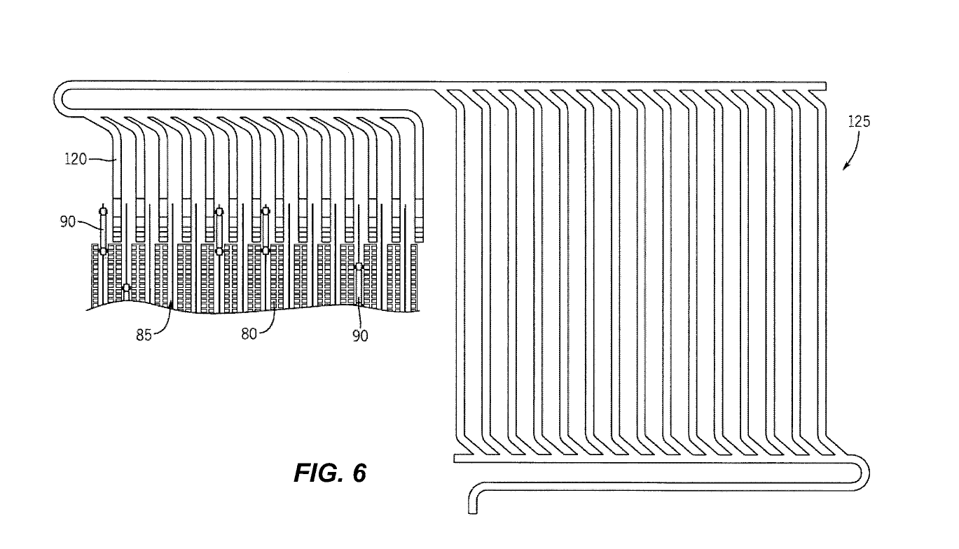

The MHCS directs units of product incoming to the ASRS 75 onto pickup and deposit (PD) conveyors 120, illustrated in FIG. 5. As illustrated in FIG. 5, one PD conveyor is assigned to one corresponding aisle 85, and thus one SRM 90 moves units of product on and off the PD conveyor 120. The MHCS directs units of product onto the PD conveyors such that the units of product with the same SKU are grouped together, whenever possible. In addition, the MHCS distributes groups of units of product with the same SKU onto different aisles 85 in a “round robin” pattern. When the group of units of product is ready for storage, the MHCS selects a shelf on the racks 80 as the destination location. When two or more groups of units of product (groups formed with units of product with different SKU) are placed on the PD conveyor 120, the MHCS directs the corresponding SRM 90 to move one group at a time. The MHCS updates the inventory information as the SRM 90 moves units of product to the shelves and generates a completed command or signal sent to the MHCS.

The WMS provides the MHCS with orders generated and entered into the system. Generally, the orders can be identified as “route truck orders”, which include a number of “customer orders”, each indicating the number of units of product required or needed. The customer orders are assigned to pallets such that all the customer orders that correspond to one route truck order are arranged onto a pallet in an arrangement that will allow ease of unloading during the distribution process. For example, the customer orders can be arranged under the direction of the MHCS such that orders to be delivered later during the truck route are placed on the bottom of the pallet while orders to be delivered early during the truck route are placed on the top. The MHCS directs the SRMs 90 to retrieve units of product from the shelves and place the units of product onto the PD conveyor 120 to be delivered to an accumulation sorter 125 (FIG. 6). The accumulation sorter 125 is utilized to sort the units of product into a configuration designed for fulfilling the existing orders and as a buffer between the ASRS 75 and the pallet building subsystem 40. The methods and/or steps for processing orders will be further described below.

From the accumulation sorter 125, units of product are released to a pallet building sorter (conveyors 115 of the pallet building sorter are partially shown in FIG. 4). Units of product are directed from the pallet building sorter to pallet building stations 105 based on orders assigned to each of the pallet building stations 105 under the direction of the MHCS. Based on the number of conveyors 115, units of product can be released concurrently to corresponding building stations 105, thus improving the palletizing and delivery processes. After pallets have been palletized, WMS directs lift trucks to deliver pallets from the pallet building system 40 to the staging/loading system 45, which includes a bulk shipping area 130 and a route truck loading area 135 (FIG. 1). More particularly, pallets from the bulk palletizing module 95 are delivered to the bulk shipping area 130 and pallets from the route palletizing module 100 are delivered to the route loading area 135 under the direction of the WMS.

In the illustrated construction, the AOFS 15 includes three modes of operation based on the automatic or manual operation of subsystems 20, 25, 30, 35, 40, 45. An automatic mode of the AOFS 15 is characterized by the control system managing the material handling equipment and operators being directed by the WMS. The automatic mode includes the WMS and the MHCS tracking and managing the inventory of units of product through the facility 10. A semi-automatic mode of the AOFS 15 is characterized by system operators controlling the SRMs 90 to store and retrieve units of product from the racks 80. In the semi-automatic mode, inventory updates at the ASRS 75 are performed by system operators. A manual mode of the AOFS 15, also defined as maintenance mode, is characterized by the control system being disabled. In the manual mode, system operators control the material handling equipment via local control panels and cabinets. The manual mode is generally implemented for maintenance purposes.

The methods and/or steps of processing orders, identified above as customer orders, include the processing of multiple orders by the AOFS 15. More particularly, the AOFS 15 is capable of concurrently processing multiple orders. The capability of the AOFS 15 to concurrently process multiple orders results in higher efficiency in handling the units of product as well as a relative increase in the through put of the units of product. It is to be understood that processing orders includes the steps from the identification of the multiple orders to the delivery of the units of product corresponding to the multiple orders. For example, the WMS can process multiple orders concurrently to improve management of the units of product in the warehouse subsystem 20. The MHCS can also process multiple orders to retrieve units of product from the ASRS 75 and fulfill the orders. The capability of the MHCS to process multiple orders generally affects to a higher degree the efficiency and through put of units of product in the system than the WMS processing multiple orders. In other words, the MHCS concurrently processing multiple orders can result in maximizing the use of mechanical equipment of the system 10. For example, the MHCS can control the ASRS 75 to retrieve units of product for various orders concurrently while still providing such units of product in a desired sequence to the palletizing subsystem 40.

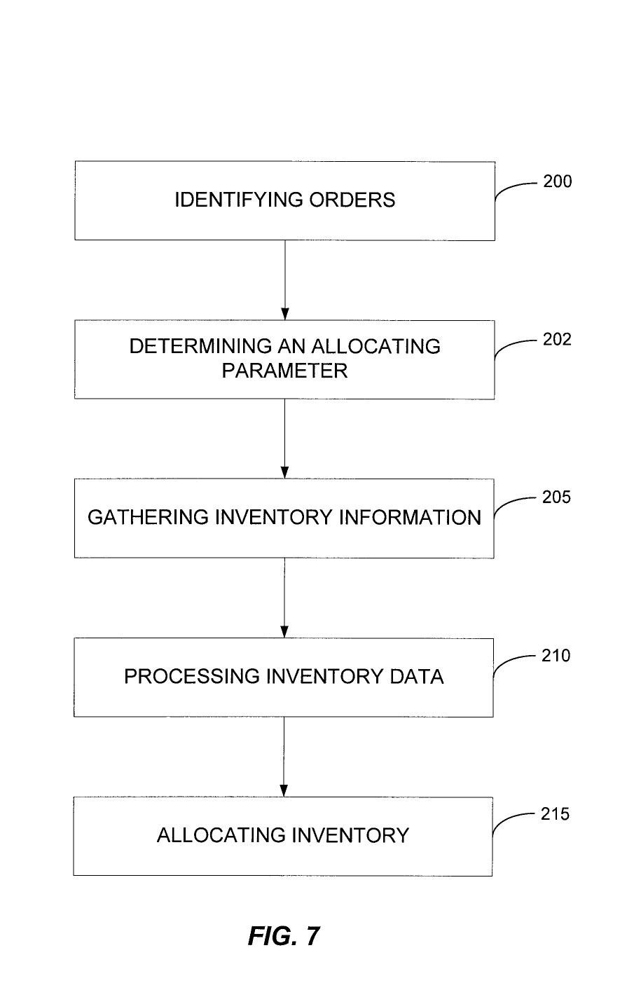

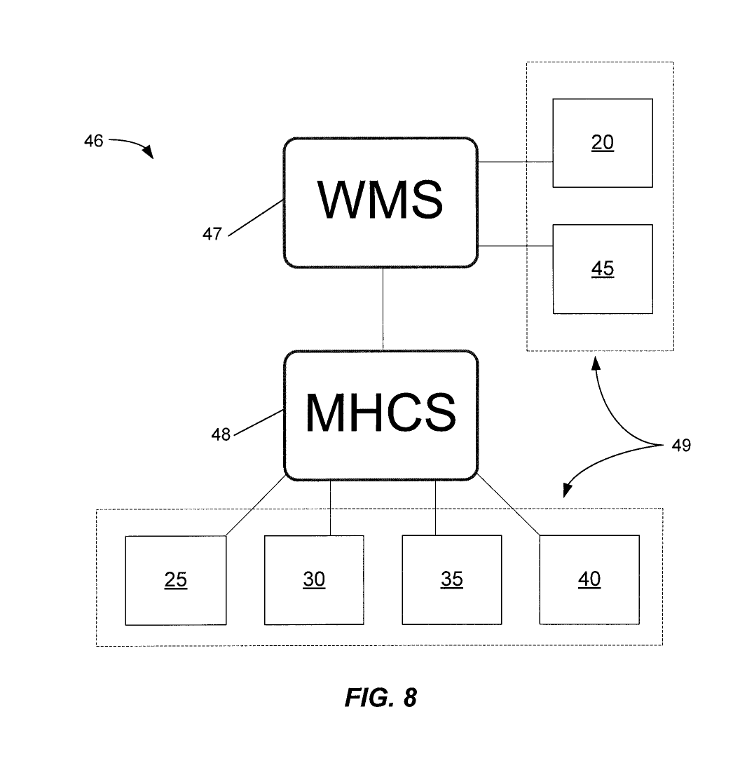

The steps for processing orders includes the orders being assigned to pallet building stations 105 for the purposes of tracking and sorting the units of product as the units of product are transported from the ASRS 75 to the pallet building stations 105. With reference to FIG. 7, processing orders includes the steps of identifying orders (step 200), determining an allocating parameter (step 202), gathering inventory information (step 205), processing the inventory information (step 210), and allocating inventory (215).

The step of identifying orders (step 200 in FIG. 7) includes sequentially identifying the orders assigned to each one of the pallet building stations 105. Each order generally includes data structures such as an order header and an order line item. The order header includes data related to a required date or origination date, and the order line item includes information related to the units necessary to fulfill the order. When the system identifies the orders assigned to the pallet building stations, orders are prioritized based on the order header information. Once the orders have been identified, the system determines an allocating parameter (step 202 in FIG. 7). The allocating parameter includes information for sorting and picking units from the ASRS 75. More specifically, the allocating parameter includes a reference date and a window of time to be utilized in combination with the reference date. In the illustrated construction, the unit of product can be cases or boxes of a beverage. Accordingly, the allocating parameter includes a date corresponding to the oldest unit of product in inventory, and a predetermined window of time (e.g., number of weeks). For example, the predetermined window of time can be utilized in combination with the date (e.g., number of weeks from the date) to help sort units by the date of manufacturing (e.g., manufacturing date being in or out of the window of time or fifo window).

The step of gathering the inventory information (step 205 in FIG. 7) includes accessing inventory information regarding the units in the ASRS 75. More specifically, the system loops though the units in each of the shelves to determine the number of useful units in each shelf. The process of determining whether a unit is “useful” can include comparing the SKU identified in the order line item with the SKU of the units in the shelf. The system also determines whether each of the groups of units identified have a destination or are scheduled to being moved to fulfill an order previously processed. The units identified as useful units by the systems are also assigned a rank for further processing. The ranking of the units is the result of comparing the number of useful units to the number of empty or available shuttles in the SRM 90, the number of useful units to the quantity of units needed to fulfill the order, and the number of useful units to the quantity of moves needed to fill the shuttles of the corresponding SRM 90. The ranking of the units is further affected by the predicted result of removing the units from the shelf. More specifically, the ranking of the units is affected by determining the status of the shelf if retrieval of the units empties the shelf or if retrieval of the units unmixes the products on the shelf, for example. The ranking information is stored by the system in a data structure for further processing of the orders. For ease of description, the data structure is identified as Shelf Info Array. It is to be understood that identification of data structures throughout this application is only for illustrative purposes and not limiting to the scope of the invention.

The step of processing the inventory information (step 210 in FIG. 7) includes accessing the information in the Shelf Info Array to determine the units to fulfill the orders being processed. More specifically, the system loops through the information of the units stored in the Shelf Info Array and determines a quantity of units needed. If the useful units in a shelf are within the fifo window, the quantity of units needed is the minimum between the quantity of useful units needed to fill the shuttles of the SRM 90 and the quantity of useful units needed to fulfill the order. If the useful units in the shelf are not within the fifo window, the quantity of units needed is the minimum between the quantity of useful units needed to fill the shuttles of the SRM 90 and the quantity of useful units to fulfill the order minus the quantity of useful units within the fifo window. Information related to the units needed within the fifo window is stored in a data structure move info. Similarly, information related to the units needed outside the fifo window is stored in a data structure best inventory. The move info data structure has priority over the best inventory data structure when the system directs the SRM 90 to retrieve units in the ASRS 75.

The system determines the quantity of units needed in the aisle per-aisle-basis. Accordingly, in cases when the quantity of units needed within the fifo window in one aisle 85 is not sufficient to fulfill an order being processed, the system loops through subsequent aisles 85 to determine whether there are available shuttles in the SRMs 90. If shuttles are available, the system proceeds to determine the quantity of units needed as described above. Furthermore, there can be situations where the system loops through all the aisles 85 for units to fulfill a current order and not enough units needed within the fifo window have been identified. In such situations, the system modifies the fifo window, generally to expand the predetermined window of time, and searches for units needed within the modified fifo window based on the information in the best inventory data structure. Information related to the units identified in the best inventory data structure that are within the modified fifo window is moved to the move info data structure. The system repeats these processes until determining enough units needed to fulfill the order being processed.

The step of allocating inventory (step 215 in FIG. 7) includes processing the information in the move info data structure to retrieve the units identified to fulfill the order being processed. More specifically, the system transforms the information in the move info data structure into data including a specific sequence of moves of the SRM(s) 90. The sequence of moves is provided to the controller of the SRM 90 and queued based on other move information that may have been received due to processing a previous order. The SRM 90 retrieves the units needed and places the units on the corresponding PD conveyor 120. The SRM 90 also generates a completed task signal for the MHCS and WMS to update inventory and track the units to the appropriate pallet building station 105.

Various features and advantages of the invention are set forth in the following claims.

What is claimed is:

1. A method of operating an automated order fulfillment system for concurrently processing multiple orders, the automated order fulfillment system including an automated storage and retrieval system having a number of storage units, each storage unit operable to support a number of stored units, and at least one building station operable to receive stored units from the automated storage and retrieval system, the method comprising:
generating the multiple orders, each order being associated with a building station;
sequentially identifying the orders associated with the building station;
accessing information relating to stored units inventory, the information including the number of stored units in each storage unit of the automated storage and retrieval system;
determining an allocating parameter, the allocating parameter including a date and a predetermined window of time;
determining a quantity of stored units needed based on the allocating parameter and the information; and
allocating stored units from the automated storage and retrieval system to the orders associated with a building station in response to determining the quantity of stored units needed.

2. The method of claim 1, wherein the order is a data structure and includes an order header with at least a date and an order line item with a quantity, the method further comprising prioritizing the orders of each building station based on the date of the order header.

3. The method of claim 1, wherein the act of accessing information includes comparing a first parameter associated to one of the multiple orders to a second parameter associated to each stored unit of the stored units inventory, and determining the quantity of useful stored units from the stored units inventory based on comparing the first parameter to the second parameter.

4. The method of claim 1, wherein the act of accessing information includes ranking useful stored units of the stored units inventory in each storage unit, and wherein the act of ranking includes
comparing a quantity of useful stored units in one storage unit to a quantity indicative of a number of shuttles associated to the one storage unit, and
sorting the useful stored units in each storage unit based on a predicted status of the storage unit determined by simulating removal of the useful stored units from the storage unit.

5. The method of claim 1, wherein the act of determining the quantity of stored units needed includes
comparing a first quantity indicative of the condition of a storage and retrieval machine of the automated storage and retrieval system to a second quantity indicative of the condition one order, and
if the quantity of stored units needed meets a condition of the allocating parameter, storing information of the quantity of stored units needed in a first data structure,
if the quantity of units needed does not meet the condition of the allocating parameter, storing information of the quantity of stored units needed in a second data structure.

6. A method of operating an automated order fulfillment system with an automated storage and retrieval system having a number of storage units, each storage unit operable to support a number of stored units, and a number of storage and retrieval machines operable to transport stored units to and from the number of storage units, each of the storage and retrieval machines including a number of shuttles, the method comprising:
determining a parameter associated with an order;
determining the quantity of useful stored units from the number of stored units in each storage unit based on the parameter associated to the order; and
ranking the quantity of useful stored units in each storage unit, the act of ranking the quantity of stored units including
comparing the quantity of useful stored units in each storage unit to at least one of a first quantity related to the order and a second quantity related to the condition of the storage and retrieval machine associated with the storage unit, and
sorting the quantity of useful stored units based on a predicted status of the storage unit determined by the removal of the quantity of useful stored units from the storage unit.

7. The method of claim 6, wherein the automated order fulfillment system further includes a number of building stations, the method further comprising
generating multiple orders including the order first mentioned, each order being associated to one corresponding building station, and
sequentially identifying the orders associated with each building station.

8. The method of claim 6, the method further comprising
determining an allocating parameter, the allocating parameter including at least one of a date and a predetermined window of time, and
comprising comparing a parameter of the quantity of stored units to the allocating parameter as a result of ranking the quantity of stored units to determine the quantity of stored units needed.

9. The method of claim 8, the method further comprising allocating stored units to each order as a result of determining the quantity of stored units needed.

10. A method of operating an automated order fulfillment system including a number of aisles formed with storage units, the storage units being operable to support a number of stored units, and a storage and retrieval machine associated with each aisle, the storage and retrieval machine including at least one shuttle, the method comprising:
sequentially verifying that the storage and retrieval machine associated with each aisle is available to transport stored units from the corresponding aisle;
determining the quantity of stored units needed from one aisle as a result of verifying that the corresponding storage and retrieval machine is available to transport stored units from the one aisle, the act of determining the quantity of stored units needed including
comparing a first quantity indicative of a condition of the available storage and retrieval machine to a second quantity indicative of a condition of an order;
determining an allocating parameter, the allocating parameter including a date and the predetermined window of time; and
if a condition of the determined quantity of stored units needed meets the allocating parameter, storing information of the quantity of stored units needed in a first data structure,
if the condition of the determined quantity of stored units needed does not meet the allocating parameter, storing information of the quantity of stored units needed in a second data structure, the first data structure including information of the quantity of stored units needed from each of the aisles and being prioritized over the second data structure.

11. The method of claim 10, wherein the automated order fulfillment system further includes a number of building stations, the method further comprising
generating multiple orders including the order first mentioned, each order being associated with one corresponding building station, and
sequentially identifying the orders associated with each building station.

12. The method of claim 10, the method further comprising accessing information of stored units inventory, the information including stored units of the number of stored units in each storage unit of the automated order fulfillment system.

13. The method of claim 10, wherein the condition of the determined quantity of stores units includes a production date, the method further comprising comparing the production date of the quantity of stored units to the allocating parameter.

14. The method of claim 10, the method further comprising allocating stored units to orders as a result of determining the quantity of stored units needed and based on information stored in and least one of the first data structure and the second data structure.

15. A method of operating an automated order fulfillment system for concurrently processing multiple orders, the automated order fulfillment system including an automated storage and retrieval system operable to support a number of stored units, the method comprising:
determining an allocating parameter, the allocating parameter including a date and a predetermined window of time;
sorting the stored units in the automated storage and retrieval system based on the allocating parameter, the act of sorting the stored units including
classifying stored units from oldest to newest based on the date of the allocating parameter, and
discarding stored units based on the predetermined window of time of the allocating parameter;
allocating stored units to an order of the multiple orders based on sorting the stored units; and
adjusting at least one of the date and predetermined window of time of the allocating parameter as a result of the allocated stored units not fulfilling the order.

16. The method of claim 15, wherein the automated order fulfillment system includes a number of building stations, the method further comprising generating a number of orders including the order first mentioned, each order being associated to one corresponding building station.

17. The method of claim 16, wherein each order is a data structure having an order header with at least a date and an order line item with a quantity, the method further comprising prioritizing the orders of each building station based on the date of the order header.

18. The method of claim 16, the method further comprising accessing information of stored units inventory, the information including stored units of the number of stored units of the automated storage and retrieval system.

19. The method of claim 18, wherein the act of accessing information of stored units inventory includes
comparing a first parameter associated to one order of the multiple orders to a second parameter associated to each stored unit of the stored units inventory, and
determining the quantity of useful stored units from the stored units inventory based on comparing the first parameter to the second parameter.

20. The method of claim 19, wherein the storage and retrieval system includes a number of storage units forming aisles and a storage and retrieval machine associated with each aisle, and wherein the act of accessing information further includes ranking the quantity of useful stored units of the stored units inventory based on comparing the quantity of useful stored units in a storage unit to a condition of the storage and retrieval machine associated with the storage unit.

21. The method of claim 20, wherein ranking useful stored units includes
comparing the quantity of useful stored units in one storage unit to a quantity indicative of a number of shuttles of the storage and retrieval machine associated with the one storage unit, and
sorting the useful units in each shelf based on a predicted status of the shelf determined by simulating removal of the useful units from the shelf.

22. The method of claim 20, the method further comprising determining a quantity of stored units needed, wherein the act of determining the quantity of stored units needed includes comparing a first quantity indicative of the condition of one storage and retrieval machine to a second quantity indicative of the condition of one order.

23. The method of claim 22, wherein determining the quantity of stored units needed further includes
if the quantity of stored units needed meets a condition of the allocating parameter, storing information of the quantity of stored units needed in a first data structure, and
if the quantity of stored units needed does not meet the condition of the allocating parameter, storing information of the quantity of stored units needed in a second data structure.

24. An automated order fulfillment system for concurrently processing multiple orders, the automated order fulfillment system comprises:
an automated storage and retrieval system having
a number of storage units, each storage unit operable to support a number of stored units,
a number of aisles formed with the storage units, and
a number of storage and retrieval machines operable to transport stored units to and from the number of storage units, each of the storage and retrieval machines being associated with one aisle and including a number of shuttles;
at least one building station operable to receive stored units from the automated storage and retrieval system; and
a control system operable to manage the orders, the control system operable to
associate each order to one building station,
generate and access information related to stored units inventory, the information including the number of stored units in each storage unit,
determine an allocating parameter, the allocating parameter including a date and a predetermined window of time,
determine a quantity of stored units needed based on the allocating parameter and the information, and
allocate stored units from the automated storage and retrieval system to the orders associated with a building station in response to determining the quantity of stored units needed.

25. The automated order fulfillment system of claim 24, further comprising
a conveyor system operable to transport stored units from the automated storage and retrieval system to the at least one building station, and
a tracking system operable to
detect stored units in the conveyor system, and
send information related to the detected stored units to the control system.
